(19) United States
(12) Patent Application Publication
(10) Pub. No.: US 2009/0289133 A1
(43) Pub. Date: Nov. 26, 2009

(54) CONTINUOUS WET GRINDING PROCESS

(76) Inventor: Jiwen F. Duan, Cary, NC (US)

Correspondence Address: Jiwen F. Duan, 207 Gingergate Drive, Cary, NC, 27519, US

(21) Appl. No.: 12/126,854

(22) Filed: May 23, 2008

(51) Int. Cl. B02C 23/38; B02C 23/36; B02C 17/16

(52) U.S. Cl. 241/15

(57) ABSTRACT

A continuous wet grinding process is disclosed for comminuting material in a liquid, comprising one or more continuous wet grinding line. Said continuous wet grinding line comprises (1) two or more sealed wet grinders connected in cascade, (2) no unsealed container connected between said grinders, (3) a positive displacement pump connected before the first sealed wet grinder in said cascade to provide the required pressure by the process flow and to regulate flow rate, (4) one or more non-volume delivery pump connected before one or more of said grinders except the first grinder in said cascade to provide necessary pressure without changing flow rate. The invention also discloses a polyester composition that contains high quality inorganic filler such as carbon black, said inorganic filler is produced in said continuous wet grinding process, which has narrower particle size distribution and less coarse particles, therefore less breaks during fiber spinning.

### FIELD OF THE INVENTION

This invention relates to a continuous wet grinding process, as well as a polyester composition containing high quality inorganic filler produced in the continuous wet grinding process.

### BACKGROUND OF THE INVENTION

Wet grinding has been widely used in chemical industry for comminuting material in a liquid, especially sand mill and pear mill. Currently the most common wet grinding process is a batch process with one sealed or unsealed wet grinder. The flow rate of process slurry into the wet grinder is controlled by the speed of positive displacement pump. There is an open container for the process slurry after the grinder. This process is good for small batch production such as paints, coatings, and inks.

Compared with one-pass with long residence time in the wet grinding mill, multiple-pass with short residence time in each pass has better product quality with narrower particle size distribution. Therefore a wet grinding system with multiple grinders connected in cascade can improve product quality.

For the grinding of large volume inorganic filler needed in chemical fiber industry, continuous production can save manpower and reduce pollution caused by equipment washing. In prior art, a wet grinding system with multiple grinders connected in cascade needs an open container after each grinder. Process slurry from the container enters the next grinder through its positive displacement pump. Operators have to check the open container very often to prevent empty container or overflow.

A continuous wet grinding process with several grinders connected in cascade without unsealed container connected between the grinders is desirable, so that operators do not have to check the container to prevent empty container or overflow. If a positive displacement pump were installed before each grinder, the system would be difficult to control without open container between the grinders. Even if the speed of each positive displacement pump were the same, the flow rate could be different, because the process slurry could have different viscosity and temperature before and after each grinding.

U.S. Pat. Nos. 5,080,293 and 5,199,656 disclosed a continuous wet grinding system with a single grinding vessel, not several grinders connected in cascade. This system is not appropriate for the continuous grinding of large volume high quality inorganic fillers slurry required in chemical fiber industry.

Therefore there is a need to develop a continuous wet grinding system which can be operated smoothly without flow disruption. This is more critical for chemical fibers industry which needs large volume of high quality inorganic filler slurry produced continuously.

### SUMMARY OF THE INVENTION

The invention discloses a continuous wet grinding process for comminuting material in a liquid, comprising one or more continuous wet grinding production line. Said continuous wet grinding production line comprises (a) two or more sealed wet grinders connected in cascade, (b) no unsealed container connected between said grinders, (c) a positive displacement pump connected before the first grinder in said cascade to provide the required pressure by the process flow and to regulate flow rate, (d) optionally one or more non-volume delivery pump connected before one or more of said grinders except the first grinder in said cascade to provide necessary pressure without changing flow rate.

The invention also discloses a polyester composition that contains high quality inorganic filler. Inorganic filler produced in said continuous wet grinding process has narrower particle size distribution, less coarse particles, therefore less breaks in polyester fiber spinning and film production.

### DETAILED DESCRIPTION OF THE INVENTION

The invention discloses a continuous wet grinding process for comminuting material in a liquid, comprising one or more continuous wet grinding production line, said continuous wet grinding production line comprises (a) two or more sealed wet grinders connected in cascade, (b) no unsealed container connected between said grinders, (c) a positive displacement pump connected before the first grinder in said cascade to provide the required pressure by the process flow and to regulate flow rate, (d) a non-volume delivery pump connected before each of the wet grinders except the first grinder in said cascade to provide necessary pressure without changing flow rate. The flow rate of process slurry is controlled by the speed of the positive placement pump of the first wet grinder, after that the process slurry enter the second wet grinder and the following wet grinders through their non-volume delivery pumps without flow rate control.

Examples of sealed wet grinder include, but are not limit to, sealed sand mill, sealed pear mill, sealed pebble mill, sealed ball mill, and sealed attritor. Most commonly used sealed wet grinders are sealed sand mill and sealed pear mill. The mill can be vertical or horizontal. The mill may have a cooling system depending on process needs. If required by the process slurry, chilled water can be used to cool the slurry, or a heat exchanger may be installed between the wet grinders.

Examples of grinding media include, but are not limit to, glass beads, zirconia silica, zirconia, steel shot. Media size is 0.1 mm to 10 mm, preferably 0.6 mm to 3 mm, most preferably 0.8 mm to 2 mm.

The process slurry contains solid from 1% to 90%, preferably 10% to 70%, more preferably 20% to 50%. The liquid can be water, ethylene glycol, or other organic or inorganic solvent.

A mix tank and a feed tank can be installed before the continuous wet grinding system. A dilution and a filter system can be installed after the continuous wet grinding system.

Examples of positive displacement pump include, but are not limit to, metering pump, reciprocating pump, piston pump, diaphragm pump, rotary pump, gear pump, screw pump, progressive cavity pump, rotary vane pump, roots pump, lobe pump, peristaltic pump, or combinations of two or more thereof. The most commonly used positive displacement pumps are diaphragm pump, gear pump, and screw pump.

Examples of non-volume delivery pump include, but are not limit to, rotodynamic pump, centrifugal pump, magnetic drive centrifugal pump, canned-motor pump, in-line pump, self-priming pump, axial flow pump, vortex pump, regenerative pump, electromagnetic pump, or combinations of two or more thereof. The most commonly used non-volume delivery pumps are centrifugal pump and magnetic drive centrifugal pump. If leaking is a concern, magnetic drive pump can be used. If solid content in the process slurry is high, the impeller of the centrifugal pump can be open or half-closed to prevent plugging.

Said wet grinding process can be operated continuously for 1 to 24 hours per day, preferably 10 to 20 hours per day, more preferably 12 to 18 hours per day, with the remaining time for maintenance.

Said sealed wet grinder, said positive displacement pump, and said non-volume delivery pump can be built with any metal or non-metal material as long as it meets the process requirement. Example of materials include, but are not limit to, ball bearing steels, carbon steels, stainless steels, titanium and titanium alloy, polyurethane, ceramics such as zirconia, and engineering plastics. Repeatedly heating and cooling can increase the hardness and reduce wearing of the steels.

Said sealed wet grinder, said positive displacement pump, and said non-volume delivery pump can be built with any suitable means by personnel who are familiar with machine manufacturing, such as joining and sealing, forging and stamping, founding, and injection molding.

Also disclosed is a continuous wet grinding process for comminuting material in a liquid, comprising one or more continuous wet grinding line, said continuous wet grinding line comprises (a) three or more sealed wet grinders connected in cascade, (b) no unsealed container connected between said grinders, (c) a positive displacement pump connected before the first sealed wet grinder in said cascade to provide the required pressure by the process flow and to regulate flow rate.

Examples of sealed wet grinder include, but are not limit to, sealed sand mill, sealed pear mill, sealed pebble mill, sealed ball mill, or sealed attritor. The most commonly used sealed wet grinders are sealed sand mill or sealed pear mill. The mill can be vertical or horizontal. The mill may have a cooling system depending on process needs. If required by the process slurry, chilled water can be used to cool the slurry, or a heat exchanger may be installed between the wet grinders.

Examples of positive displacement pump include, but are not limit to, metering pump, reciprocating pump, piston pump, diaphragm pump, rotary pump, gear pump, screw pump, progressive cavity pump, rotary vane pump, roots pump, lobe pump, peristaltic pump, or combinations of two or more thereof. Commonly used positive displacement pumps are diaphragm pump, gear pump, and screw pump.

One or more non-volume delivery pump can be connected before one or more of the sealed wet grinders except the first grinder in said continuous wet grinding line to provide necessary pressure without changing flow rate.

Examples of non-volume delivery pump include, but are not limit to, rotodynamic pump, centrifugal pump, magnetic drive centrifugal pump, canned-motor pump, in-line pump, self-priming pump, axial flow pump, vortex pump, regenerative pump, electromagnetic pump, or combinations of two or more thereof. The most commonly used non-volume delivery pumps are centrifugal pump and magnetic drive centrifugal pump. If leaking is a concern, magnetic drive pump can be used. If solid content in the process slurry is high, the impeller of the centrifugal pump can be open or half-closed to prevent plugging.

Except the first grinder, not all of the later grinders need a connected pump. I found that when fewer non-volume delivery pumps are connected to later grinders, the front grinders have higher pressure, therefore higher energy intensity and higher grinding efficiency. But removing all non-volume delivery pumps connected to the later grinders may result in pressure in the front grinders too high, therefore causes leaking. Unless the front grinders are manufactured to withstand much higher pressure, some non-volume delivery pumps connected to later grinders are necessary.

Further disclosed is a composition comprising repeat units derived from a carbonyl compound or oligomer thereof and a glycol as well as inorganic filler, wherein said carbonyl compound is HO—R—COOH or R′OOCACOOR′; A is an alkylene group, arylene group, alkenylene group, or combinations of two or more thereof having 2 to 30 carbon atoms per group; each R or R′ is independently selected from (i) hydrogen, (ii) a hydrocarboxyl radical having a carboxylic acid group at the terminus, or (iii) a hydrocarbyl radical in which each radical has 1 to 30 carbon atoms per radical selected from an alkyl, alkenyl, aryl, alkaryl, aralkyl radical, or combinations of two or more thereof, said oligomer has 2 to 100 repeat units;

said inorganic filter is produced in a continuous wet grinding process with one or more continuous wet grinding production line comprising (a) two or more wet grinders connected in cascade, (b) no unsealed container connected between said grinders, (c) a positive displacement pump connected before the first sealed grinder in said cascade to provide the required pressure by the process flow and to regulate flow rate, (d) optionally one or more non-volume delivery pump connected before one or more of the sealed wet grinders except the first grinder in said cascade to provide necessary pressure without changing flow rate; said inorganic filler is 0.01% to 10% of said composition.

Example of carbonyl compounds include, but are not limit to, terephthalic acid, isophthalic acid, napthalic acid, dimethyl terephthalate, adipic acid, dimethyl isophthalate, dimethyl napthalate, or combinations of two or more thereof, Example of glycol include, but are not limit to, ethylene glycol, 1,2-propanediol, 1,3-propanediol, 1,4-butanediol, 1,4-cyclohexanedimethanol, diethylene glycol, polyethylene glycol, or combinations of two or more thereof.

Examples of inorganic filler include, but are not limit to, titanium dioxide, carbon black, barium sulfate, and silicon dioxide. Inorganic filler slurry produced in the continuous sand mill system has narrower particle size distribution, less coarse particles, more uniform dispersion in polyester, therefore less breaks in fiber spinning and film production. A high quality slurry of inorganic filler should pass 500 to 5000 ml in vacuum filtration of 325×2300 mesh (stainless steel screen diameter 57 mm).

Polyester containing carbon black 0.3% to 3% does not need to dye, which completely solves the pollution problem during the fiber dyeing.

Titanium dioxide is a deluster for polyester fiber. Semidull polyester fibers contain TiO₂ 0.2% to 0.5% by weight, dull polyester fibers contain TiO₂ 1% to 3%.

Polyesters containing barium sulfate or silicon dioxide 0.1% to 1% have improved spinning performance and other processing properties.

### EXAMPLES

The following examples are included to further illustrate the invention and are not to be construed as to unduly limit the scope of the invention.

### Example 1

A continuous wet grinding process with three parallel sand mill production lines, each line has three sealed horizontal sand mills of 250 L connected in cascade. The first sand mill of each production line has a diaphragm pump to provide the required pressure by the process flow and to regulate flow rate. The second and third sand mill each has a centrifugal pump to provide necessary pressure without changing flow rate. There is no unsealed container between the sand mills. Each sand mill has a water cooling system. Mill media is 1.0-1.2 mm zirconia silica (containing ZrO₂ 64%, SiO₂ 33%), media is filled to 80% of the grinding volume.

The process slurry contains carbon black 25%, solvent ethylene glycol and dispersant 75% by weight. Ethylene glycol and dispersant 3000 kg is first added to a mixed tank of 9.1 m³, and then carbon black powder 1000 kg is added to the agitated tank, which is agitated for 1 hour after carbon black is added. The black slurry is pumped to a feed tank of 13.3 m³, then the black slurry enter the first sand mill of each line through the diaphragm pump which control flow rate to 480 kg per hour. The outflow of the first sand mill enters a centrifugal pump and then the second sand mill. The outflow of the second sand mill enters a centrifugal pump and then the third sand mill. The outflow of the third sand mill enters an intermediate tank of 9.1 m³. The slurry then is diluted with ethylene glycol to 20% in a dilution tank of 9.1 m³. After a filter system, the slurry enters a storage tank of 30 m³.

The 20% black slurry produced in the continuous wet grinding system is added into the polymerization process of polyethylene terephthalate 300 tons per day. During the production of gray polyester fibers 300 tons per day (containing TiO₂ 0.3% and carbon black 0.6%), the carbon black wet grinding system is operated continuously for 5 hours per day. During the production of black polyester fibers 300 tons per day (containing carbon black 2%), the carbon black wet grinding system is operated continuously for 16.6 hours per day.

### Example 2

A continuous sand mill process is similar to that in EXAMPLE 1, except it has only one continuous sand mill production line comprising three sealed horizontal sand mills of 250 L connected in cascade. Process slurry is TiO₂ 55.5% in ethylene glycol, flow rate is 1500 kg per hour. TiO₂ 55.5% slurry is diluted to 20% after sand mill.

The 20% TiO₂ slurry produced in the continuous wet grinding system is added into the polymerization process of polyethylene terephthalate 600 tons per day. During the production of semidull polyester fibers 600 tons per day (containing TiO₂ 0.3%), the TiO₂ wet grinding system is operated continuously for 2 hours 10 minutes per day. In the production of dull polyester fibers 600 tons per day (containing TiO₂ 2.5%), the TiO₂ wet grinding system is operated continuously for 18 hours per day.

### Example 3

A continuous wet grinding process with two parallel sand mill production lines, each line has four sealed horizontal sand mills of 250 L connected in cascade. The first sand mill of each production line has a screw pump to provide the required pressure by the process flow and to regulate flow rate. The other three sand mills each has a magnetic centrifugal pump with bypass piping and valves. There is no unsealed container connected between the sand mills. Each sand mill has a cooling system. Mill media is 1.0-1.2 mm zirconia silica (containing ZrO₂ 64%, SiO₂ 33%), media is filled to 80% of the grinding volume.

The process slurry contains carbon black 25% and ethylene glycol and dispersant 75%. Ethylene glycol and dispersant 3000 kg is first added to a mixed tank of 9.1 m³, and then carbon black powder 1000 kg is added to the agitated tank, which is agitated for 1 more hour after carbon black is added. The black slurry is pumped to a feed tank of 13.3 m³, then the black slurry enters the first sand mill of each line through the diaphragm pump which control flow rate to 640 kg per hour. The outflow of the first sand mill enters a centrifugal pump and then the second sand mill. The outflow of the second sand mill enters a centrifugal pump and then the third sand mill. The outflow of the third sand mill enters a centrifugal pump and then the fourth sand mill. The four sand mills each has pressure around 0.05 MPa. The outflow of the fourth sand mill enters an intermediate tank of 9.1 m³. The slurry then is diluted with ethylene glycol to 20% in a dilution tank of 9.1 m³. After a filter system, the slurry enters a storage tank of 30 m³.

Vacuum filtration is used to check the quality of the produced carbon black slurry. The stainless steel screen of 57 mm in diameter is 325×2300 mesh. Carbon black slurry of 600 ml passed the screen before plugging.

### Example 4

The continuous wet grinding process is the same as that in EXAMPLE 3. The outflow of the first sand mill bypasses the centrifugal pump and enters the second sand mill. The outflow of the second sand mill enters a magnetic centrifugal pump and then the third sand mill. The outflow of the third sand mill bypasses the centrifugal pump and enters the fourth sand mill. The first and the third sealed sand mill has pressure around 0.1 MPa, the second and the fourth sealed sand mill had pressure around 0.05 MPa.

In vacuum filtration quality check, carbon black slurry of 800 ml passed the screen before plugging.

I claim:

1. A continuous wet grinding process for comminuting material in a liquid, comprising one or more continuous wet grinding line, said continuous wet grinding line comprises (1) two or more sealed wet grinders connected in cascade, (2) no unsealed container connected between said grinders, (3) a positive displacement pump connected before the first grinder in said cascade to provide the required pressure by the process flow and to regulate flow rate, (4) a non-volume delivery pump connected before each of the sealed wet grinders except the first grinder in said cascade to provide necessary pressure without changing flow rate.

2. A process according to claim 1 wherein said sealed wet grinder is sealed sand mill, sealed pear mill, sealed pebble mill, sealed ball mill, or sealed attritor.

3. A process according to claim 2 wherein said sealed wet grinder is sealed sand mill or sealed pear mill.

4. A process according to claim 1 wherein said positive displacement pump is metering pump, reciprocating pump, piston pump, diaphragm pump, rotary pump, gear pump, screw pump, progressive cavity pump, rotary vane pump, roots pump, lobe pump, peristaltic pump, or combinations of two or more thereof.

5. A process according to claim 4 wherein said positive displacement pump is diaphragm pump, gear pump, or screw pump.

6. A process according to claim 1 wherein said non-volume delivery pump is rotodynamic pump, centrifugal pump, magnetic drive centrifugal pump, canned-motor pump, in-line pump, self-priming pump, axial flow pump, vortex pump, regenerative pump, electromagnetic pump, or combinations of two or more thereof.

7. A process according to claim 6 wherein said non-volume delivery pump is centrifugal pump or magnetic drive centrifugal pump.

8. A continuous wet grinding process for comminuting material in a liquid, comprising one or more continuous wet grinding line, said continuous wet grinding line comprises (1) three or more sealed wet grinders connected in cascade, (2) no unsealed container connected between said grinders, (3) a positive displacement pump connected before the first grinder in said cascade to provide the required pressure by the process flow and to regulate flow rate.

9. A process according to claim 8 wherein said sealed wet grinder is sealed sand mill, sealed pear mill, sealed pebble mill, sealed ball mill, or sealed attritor.

10. A process according to claim 9 wherein said sealed wet grinder is sealed sand mill or sealed pear mill.

11. A process according to claim 10 wherein said positive displacement pump is metering pump, reciprocating pump, piston pump, diaphragm pump, rotary pump, gear pump, screw pump, progressive cavity pump, rotary vane pump, roots pump, lobe pump, peristaltic pump, or combinations of two or more thereof.

12. A process according to claim 11 wherein said positive displacement pump is diaphragm pump, gear pump, or screw pump.

13. A process according to claim 8 wherein one or more non-volume delivery pump is connected before one or more of the sealed wet grinders except the first grinder in said continuous wet grinding line to provide necessary pressure without changing flow rate.

14. A process according to claim 13 wherein said non-volume delivery pump is rotodynamic pump, centrifugal pump, magnetic drive centrifugal pump, canned-motor pump, in-line pump, self-priming pump, axial flow pump, vortex pump, regenerative pump, electromagnetic pump, or combinations of two or more thereof.

15. A process according to claim 14 wherein said non-volume delivery pump is centrifugal pump or magnetic drive centrifugal pump.

16. A composition comprising repeat units derived from a carbonyl compound or oligomer thereof and a glycol as well as inorganic filler, wherein
said carbonyl compound is HO—R—COOH or R′OOCACOOR′;
A is an alkylene group, arylene group, alkenylene group, or combinations of two or more thereof having 2 to 30 carbon atoms per group;
each R or R′ is independently selected from (i) hydrogen, (ii) a hydrocarboxyl radical having a carboxylic acid group at the terminus, or (iii) a hydrocarbyl radical in which each radical has 1 to 30 carbon atoms per radical selected from an alkyl, alkenyl, aryl, alkaryl, aralkyl radical, or combinations of two or more thereof;
said oligomer has 2 to 100 repeat units;
said inorganic filter is produced in a continuous wet grinding process with one or more continuous wet grinding line comprising (1) three or more sealed wet grinders connected in cascade, (2) no unsealed container connected between said grinders, (3) a positive displacement pump connected before the first sealed wet grinder in said cascade to provide the required pressure by the process flow and to regulate flow rate, (4) optionally one or more non-volume delivery pump connected before one or more of said grinders except the first grinder in said cascade to provide necessary pressure without changing flow rate; said inorganic filler is 0.01% to 10% of said composition.

17. A composition according to claim 14 wherein said carbonyl compound is terephthalic acid, isophthalic acid, napthalic acid, adipic acid, dimethyl terephthalate, dimethyl isophthalate, dimethyl napthalate, or combinations of two or more thereof; said glycol is ethylene glycol, 1,2-propanediol, 1,3-propanediol, 1,4-butanediol, 1,4-cyclohexanedimethanol, diethylene glycol, polyethylene glycol, or combinations of two or more thereof.

18. A composition according to claim 16 wherein said inorganic filler is carbon black.

19. A composition according to claim 16 wherein said inorganic filler is titanium dioxide.

20. A composition according to claim 16 wherein said inorganic filler is barium sulfate or silicon dioxide.
